(19) United States
(12) Patent Application Publication
(10) Pub. No.: US 2025/0159290 A1
(43) Pub. Date: May 15, 2025

(54) INFORMATION DISPLAY METHOD, ELECTRONIC DEVICE AND STORAGE MEDIUM

(71) Applicant: Beijing Zitiao Network Technology Co., Ltd., Haidian District, Beijing (CN)

(72) Inventors: Jiaxin WANG, Beijing (CN); Ting YANG, Beijing (CN)

(21) Appl. No.: 18/839,246

(22) PCT Filed: Mar. 6, 2023
(86) PCT No.: PCT/CN2023/079728

§ 371 Date: Aug. 16, 2024

(30) Foreign Application Priority Data
Mar. 9, 2022 (CN) 202210225176.1

(51) Int. Cl. H04N 21/462; H04N 21/45

(52) U.S. Cl. CPC H04N 21/4622; H04N 21/4532

(57) ABSTRACT

An information display method, an apparatus, an electronic device, a storage medium, and a program product are provided. The information display method includes: playing a first content on a media content playing interface; and switching the first content to a second content in response to a content switching operation by a first user based on a media content stream in the media content playing interface, wherein the second content is associated information of a target object, the associated information comprises description information of the target object, and at least part of the associated information is displayed in a form of dynamic comment information.

This application claims the priority to and benefits of Chinese Patent Application No. 202210225176.1, filed on Mar. 9, 2022, and the aforementioned patent application is hereby incorporated by reference in its entirety.

### TECHNICAL FIELD

Embodiments of the present disclosure relates to the field of computer technology, for example, to an information display method, an apparatus, an electronic device, a storage medium, and a program product.

### BACKGROUND

Currently, users can watch videos on video playing interfaces. However, in related technologies, the contents displayed on video playing interfaces are relatively simple and cannot meet the needs of users.

### SUMMARY

Embodiments of the present disclosure provide an information display method, an apparatus, an electronic device, a storage medium, and a program product.

In a first aspect, an embodiment of the present disclosure provides an information display method, which includes:
playing a first content on a media content playing interface;
switching the first content to a second content in response to a content switching operation by a first user based on a media content stream in the media content playing interface, wherein the second content is associated information of a target object, the associated information includes description information of the target object, and at least part of the associated information is displayed in the form of dynamic comment information.

In a second aspect, an embodiment of the present disclosure also provides an information display apparatus, which includes:
a first playing module, configured to a first content on a media content playing interface;
an information display module, configured to switch the first content to a second content in response to a content switching operation by a first user based on a media content stream in the media content playing interface, wherein the second content is association information of a target object, the associated information includes description information of the target object, and at least part of the associated information is displayed in the form of dynamic comment information.

In a third aspect, an embodiment of the present disclosure also provides an electronic device, comprising:
at least one processor, and
a memory in communication with the at least one processor;
the memory stores a computer program executable by the at least one processor, upon the computer program being executed by the at least one processor, the at least one processor executes the information display method according to any one of the information display methods according to embodiments of the present disclosure.

In a fourth aspect, an embodiment of the present disclosure also provides a computer-readable storage medium, on which computer instructions are stored, the computer instructions are used to enable the processor to implement the information display methods according to embodiments of the present disclosure.

In a fifth aspect, an embodiment of the present disclosure provides a computer program product, when the computer program product is executed by a processor, the information display methods according to embodiments of the present disclosure are implemented.

### BRIEF DESCRIPTION OF DRAWINGS

Throughout the drawings, the same or similar reference numbers refer to the same or similar elements. It is to be understood that the drawings are schematic and that components and elements are not necessarily drawn to scale.

FIG. 1 is a schematic flowchart of an information display method provided by an embodiment of the present disclosure;

FIG. 2 is a schematic diagram of displaying a second content provided by an embodiment of the present disclosure;

FIG. 3 is a schematic flowchart of another information display method provided by an embodiment of the present disclosure;

FIG. 4 is a structural block diagram of an information display apparatus provided by an embodiment of the present disclosure; and

FIG. 5 is a schematic structural diagram of an electronic device provided by an embodiment of the present disclosure.

### DETAILED DESCRIPTION

Embodiments of the present disclosure will be described below with reference to the accompanying drawings. While certain embodiments of the present disclosure are illustrated in the accompanying drawings, it is to be understood that the present disclosure may be embodied in various forms and should not be construed as limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

It should be understood that the various steps recited in the method implementation of the present disclosure may be performed in a different order, and/or in parallel. Further, the method implementation may include additional steps and/or omit performing illustrated steps. The scope of the present disclosure is not limited in this regard.

As used herein, the term “include” and its variations are open inclusion, that is, means “including, but not limited to”. The term “based on” is “based at least in part on.” The term “one embodiment” means “at least one embodiment”; the term “another embodiment” means “at least one additional embodiment”; the term “some embodiments” means “at least some embodiments”. Relevant definitions for other terms will be given in the description below.

It should be noted that the concepts such as “first”, “second” and the like mentioned in the present disclosure are only used to distinguish different apparatuses, modules or units, and are not used to limit the sequence or interdependence of the functions performed by these apparatuses, modules or units.

It is noted that the modifications referred to as “a” or “a plurality” in this disclosure are illustrative rather than limiting, and those skilled in the art should understand that it should be understood as “one or more” unless the context clearly indicates otherwise.

The names of messages or information exchanged between multiple apparatuses in the embodiments of the present disclosure are for an illustrative purpose only and are not used to limit the scope of these messages or information.

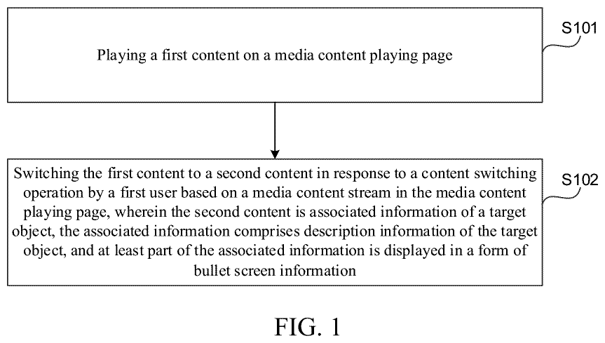

FIG. 1 is a schematic flowchart of an information display method provided by an embodiment of the present disclosure. The method can be performed by an information display apparatus, the apparatus can be implemented by software and/or hardware, and can be configured in an electronic device, typically a mobile phone or a tablet computer. The information display method provided by the embodiment of the present disclosure can display the associated information of a target object in a media content playing interface. For example, the associated information of the target object can be displayed in the video playing interface. As shown in FIG. 1, the information display method provided by this embodiment may include the following steps.

S101, playing a first content on a media content playing interface.

The media content playing interface may be an interface used to play a media content such as a video content, an audio content, etc. The first content may be the media content played in the media content playing interface, such as a video content or an audio content which is played in the media content playing interface when the content switching operation is received. The following description takes the media content playing interface as the video playing interface and the first content as the video content as an example.

For example, the electronic device may display a media content playing interface based on the corresponding triggering operation of a first user, and play the media content (including the first media content) in the media content stream on the media content playing interface.

S102, switching the first content to a second content in response to a content switching operation by a first user based on a media content stream in the media content playing interface, wherein the second content is associated information of a target object, the associated information includes description information of the target object, and at least part of the associated information is displayed in a form of bullet comments information.

The first user can be understood as the current user, such as the user who performs the content switching operation. The media content stream can be the content stream of the media content playing interface, when the media content playing interface is a video playing interface, the media content stream can be the video stream of the video playing interface. The content switching operation may be an operation of switching the media content played in the media content playing interface based on the media content stream, such as the operation of switching the first content played in the media content playing interface to the media content adjacent to the first content in the media content stream; the content switching operation may be, for example, a vertical sliding operation on the media content playing interface.

The target object may be an object recommended to the first user, such as a place (such as a shopping mall, scenic spot, store) that is recommended to the first user, etc. In an example, the positional relationship between the target object and the first user satisfies a preset condition. The preset condition can be set flexibly. For example, the city in which the preset condition is set can be the same as the city to which the first user's location belongs, or the distance between the location and the first user's location is less than or equal to the threshold of the preset condition, etc. The location of the first user may be the current location of the first user or a preset location of the first user, the current location may be determined by locating the first user after the first user authorizes to locate; the preset location may be set by the first user. For example, the target object may be the place in the same city as the first user's current location or preset location, or the place the distance from which to the current location/preset location of the first user is within a preset distance threshold. It should be noted that the user's location information is obtained and used with full authorization from the user and relevant party or parties on the premise of complying with laws and regulations.

The second content may be the associated information of the target object, which may include description information of the target object (such as the name of the target object, the geographical location of the target object, the featured commodity/product/store, per capita consumption, etc. in the target object); the associated information may also include the relationship information between the target object and the first user, the operation information performed by the second user with respect to the target object, and/or the relationship information between the target object and the target object set. At least part of the associated information of the target object can be displayed in the form of bullet comments information. For example, the description information of the target object can be displayed in a fixed display manner, and the relationship information between the target object and the first user, the operation information performed by the second user with respect to the target object, and/or the relationship between the target object and the target object can be displayed in the form of bullet comments information. In this case, in one example, the bullet comments information includes at least one selected from the group consisting of the relationship information between the target object and the first user, the operation information performed by a second user with respect to the target object and, the relationship information between the target object and a target object set. The second user may be a user other than the first user. Each piece of the bullet comments information can move along the set direction (such as from right to left or from bottom to top, etc.) within the media content playing interface or within the set area of the media content playing interface.

For example, the relationship information between the target object and the first user may be information describing the relationship between the target object and the first user. For example, the relationship information between the target object and the first user includes: the distance information between the target object and the first user and/or the operation information performed by the first user with respect to the target object. The operation information performed by the first user with respect to the target object (including sub-objects included in the target object) may include, for example, the comment information posted or interaction information performed by the first user with respect to the target object. The interaction information performed by the first user with respect to the target object may include like information, sharing information, or collection information, etc., such as information prompting that the target object is an object that the first user has liked, shared, or collected.

The operation information performed by the second user with respect to the target object includes: the evaluation information posted or the interaction information performed by the second user with respect to the target object. The interaction information performed by the second user with respect to the target object may include (including sub-objects included in the target object), for example, the like information, sharing information or collection information of the second user with respect to the target object, such as the information on the number of likes, the number of shares, or the number of favorites of the target object, etc.

The relationship information between the target object and the target object set may include: the ranking information of the target object in the target object set and/or the evaluation level information of the target object in the target object set. The target object set can be the set in which the target object is located, such as the set of objects of the same type. When the target object is a place, the target object set can be a set of places of the same type, such as a set of places of the same type in a city.

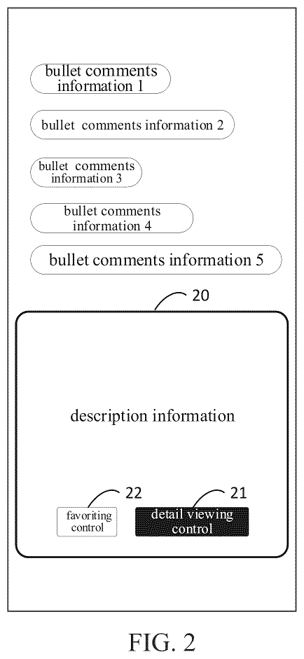

For example, when the current condition meets the preset condition of the recommended target object, the second content can be added to the media content stream on the media content playing interface. Therefore, when the user wants to switch the first content played in the media content play interface to other content in the media content stream based on the media content stream, the user can perform a content switching operation in the media content playing interface. Correspondingly, when the electronic device detects the user's content switching operation, the electronic device can determine the media content to be displayed based on the user's content switching operation and the arrangement order of media contents in the media content stream, and display the second content in the media content playing interface when the media content to be displayed is the second content, for example, the description information of the target object can be fixedly displayed on the media content playing interface, and the relationship information between the target object and the first user, the operation information performed by the second user with respect to the target object, and/or the relationship information between the target object and the target object set can be displayed in the form of bullet comments message, as shown in FIG. 2.

In this embodiment, the associated information of the target object recommended to the user is displayed on the media content playing interface, and at least part of the associated information of the target object is displayed in the form of bullet comments information, so that the user can quickly understand the target object without switching to other interfaces or other applications, which can enrich the content displayed on the media content playing interface and the presentation form of the content on the media content playing interface, and improve the user's information viewing efficiency, thereby improving the user experience.

The information display method provided by this embodiment plays a first content on a media content playing interface, and switches the first content to a second content in response to a content switching operation by a first user based on a media content stream in the media content playing interface; the second content is the associated information of a target object, the associated information includes the description information of the target object, and at least part of the associated information is displayed in the form of bullet comments information. In this embodiment, the associated information of the target object is displayed to the user in the media content playing interface, and at least part of the associated information of the target object is displayed in the form of bullet comments information, thus the contents displayed on the media content playing interface and the presentation forms of the content on the media content playing interface become diversified, and the user's information viewing efficiency and user experience are improved.

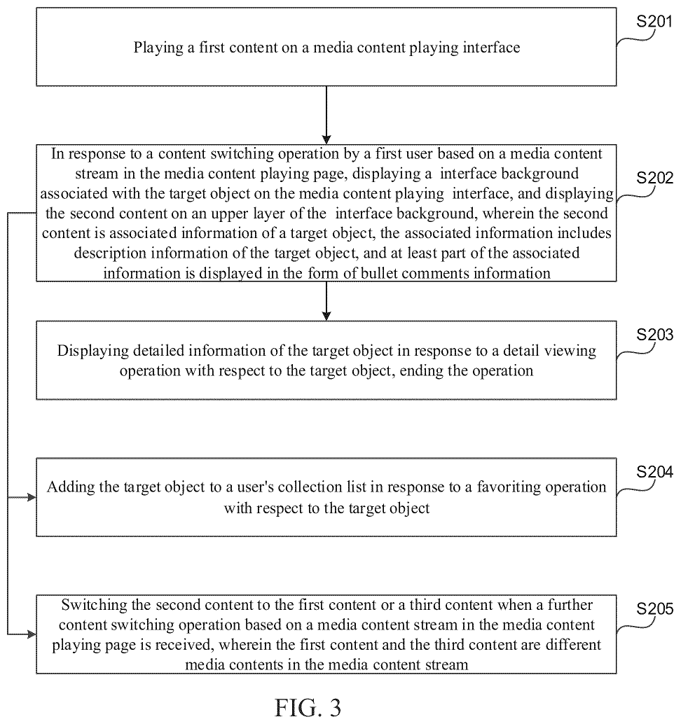

FIG. 3 is a schematic flowchart of another information display method provided by an embodiment of the present disclosure. This embodiment may be combined with one or more of the above embodiments. In an embodiment, after switching the first content to the second content, the method further includes: displaying detailed information of the target object in response to a detail viewing operation with respect to the target object.

In an embodiment, after the switching the first content to the second content, the method further includes: adding the target object to a user's favorites list in response to a favoriting operation with respect to the target object.

In an embodiment, the switching of the first content to the second content includes: displaying a interface background associated with the target object on the media content playing interface, and displaying the second content on an upper layer of the interface background.

In an embodiment, after the switching the first content to the second content, the method further includes: switching the second content to the first content or a third content in response to a further content switching operation by the first user based on a media content stream in the media content playing interface; the first content and the third content are different media contents in the media content stream.

Correspondingly, as shown in FIG. 3, the information display method provided by the embodiment may include the following steps:

S201, playing a first content on a media content playing interface;

S202, in response to a content switching operation by a first user based on a media content stream in the media content playing interface, displaying a interface background associated with the target object on the media content playing interface, and displaying the second content on an upper layer of the interface background, wherein the second content is associated information of a target object, performing steps S203, S204 or S205, the associated information includes description information of the target object, and at least part of the associated information is displayed in the form of bullet comments information.

The interface background may be the interface background displayed on the media content playing interface when the second content is displayed. For example, the interface background may be a picture content (such as a static picture or a dynamic picture), an animation content or a video content associated with the target object. The interface background can be preset by the developer; the interface background can also be determined based on the media content that is posted by the first user and/or the second user and associated with the target object. For example, at least one picture can be extracted from the media content associated with the target object posted and authorized for use by users (including the first user and the second user) and used as the interface background when the second content is displayed.

For example, as shown in FIG. 2, when receiving the content switching operation of the first user, the electronic device can stop playing the first content, and display the interface background associated with the target object in the media content playing interface (not shown in FIG. 2), and display the associated information of the target object (i.e., the second content) on the upper layer of the background of the interface, for example, the description information of the target object is displayed in a preset area on the upper layer of the interface background, and the relationship information between the target object and the first user, the operation information performed by the second user with respect to the target object, and/or the relationship information between the target object and the target object set are displayed in another preset area on the upper background of the interface.

In this embodiment, the display way of the description information of the target object can be flexibly set. For example, the description information of the target object can be displayed directly on the upper layer of the interface background; an object card 20 of the target object can also be displayed on the upper layer of the interface background, and the object card 20 of the target object can be displayed on the upper layer of the interface background. The description information of the target object is displayed in the object card 20 of the target object, as shown in FIG. 2. In this case, for example, displaying of the second content on the upper layer of the interface background includes: displaying the object card 20 of the target object and the bullet comments information on the upper layer of the interface background, the object card being used to display the description information of the target object. The bullet comments information of the target object can be understood as the associated information of the target object displayed in the form of bullet comments information, such as the relationship information between the target object and the first user, the operation information performed by the second user with respect to the target object, and/or the relationship information between the target object and the target object set, etc.

When the object card of the target object is displayed, the background color of the object card (i.e., the first background color) can be a preset color; the background color can also be the color of the interface background displayed in the media content (i.e., the second background color), for example, the first background color of the object card is determined based on the second background color of the interface background displayed in the media content playing interface, so as to enhance the diversity of the object card of the target object when the object card is displayed. When determining the first background color of the object card based on the second background color of the interface background, for example, the middle color of the interface background, the color with the largest or smallest proportion in the interface background, etc. can be used as the first background color of the object card.

In one implementation, there may be a plurality of interface backgrounds associated with the target object. Therefore, when the associated information (i.e., the second content) of the target object is displayed, the interface background of the media content playing interface can be switched according to the preset switching condition, and update the background color of the object card of the target object displayed in the media content playing interface based on the color of the switched interface background. In this case, after displaying an object card of the target object and the bullet comments information on the upper layer of the interface background, the method may also include: switching the interface background displayed in the media content playing interface according to a preset switching condition, and updating the first background color of the object card based on the second background color of a switched interface background. The preset switching condition can be set flexibly, for example, the preset switching condition can be set to periodic switching or switching when a user's setting triggering operation is received, etc. This embodiment does not limit in this way.

S203, displaying detailed information of the target object in response to a detail viewing operation with respect to the target object, ending the operation.

The detail viewing operation may be an operation of viewing detailed information of the target object. The detail viewing operation may be, for example, a click operation acting on an area where no control is displayed on the media content playing interface, such as a blank area on the media content playing interface, a click operation on the second content displayed on the media content playing interface; or a triggering operation on the detail viewing control displayed on the media content playing interface, etc.

For example, when the user wants to view the detailed information of the target object, a detail viewing operation for the target object can be performed, such as clicking on a blank area of the media content playing interface, the second content displayed on the media content playing interface, or a detail viewing control 21 displayed on the media content playing interface (as shown in FIG. 2). Correspondingly, when receiving the user's detail viewing operation, the electronic device can display the detailed information of the target object to the user. For example, the detailed information of the target object can be displayed on the media content playing interface, such as displaying the target object in the object card of the target object, or the electronic device can display the detailed information of the target object on the upper layer of the object card of the target object; the current interface can also be switched from the media content playing interface to the target object's detail interface, and the target object's detailed information is displayed on the detail interface.

In an embodiment, the bullet comments information includes the evaluation information posted by the second user with respect to the target object, and the displaying of the detailed information of the target object includes: switching a current interface from the media content playing interface to a detail interface of the target object, and displaying a preset first interface content in the detail interface.

The target object's detail interface may be an interface used to display the detailed information of the target object. The content of the first interface may be preset and displayed by default when switching to the detail interface of the target object.

In the above embodiment, the bullet comments information may include the evaluation information with respect to the target object, such as the evaluation information posted by the first user and/or the second user with respect to the target object. When the user performs a detail viewing operation by triggering the evaluation information of the target object, and when the user performs a detail viewing operation through another way (such as triggering other information than the evaluation information in the second content or triggering the detail viewing control displayed on the media content playing interface) to perform a detail viewing operation, the same interface content can be displayed in the detail interface of the target object. That is, when the user performs a detail viewing operation by triggering the evaluation information of the target object, it is not necessary to locate the evaluation information triggered by the user in the detail interface of the target object.

In another embodiment, the bullet comments information includes the evaluation information posted by the second user with respect to the target object, and the displaying of detailed information of the target object includes: switching a current interface from the media content playing interface to a detail interface of the target object, and displaying a preset first interface content in the detail interface; the content of the second interface includes the evaluation information triggered by the detail viewing operation.

The content of the second interface may be the interface content containing the comment information triggered by the user.

In the above embodiment, the bullet comments information may include the evaluation information with respect to the target object, such as the evaluation information posted by the first user and/or the second user with respect to the target object. When the user performs a detail viewing operation by triggering the evaluation information of the target object, and when the user performs the detail viewing operation in other way, a different interface content can be displayed on the detail interface of the target object, for example when the user performs a detail viewing operation by triggering the evaluation information of the target object, the evaluation information triggered by the user can be located, and the interface content containing the evaluation information triggered by the user is displayed on the details interface, for example, the interface content including the evaluation information triggered by the user and other information adjacent to the evaluation information triggered by the user in the detail interface is displayed on the detail interface, so that the user can view the evaluation information triggered by the user on the detail interface.

S204, adding the target object to a user's favorites list in response to a favoriting operation with respect to the target object.

The favoriting operation can be an operation of collecting target object, such as a triggering operation on the collection control that is displayed on the media content playing interface, etc.

For example, when the user wants to collect a target object, a favoriting operation with respect to the target object can be performed, such as triggering the favoriting control 22 displayed on the media content playing interface (as shown in FIG. 2). Correspondingly, when receiving the user's favoriting operation, the electronic device can add the target object to the user's favorites list, such as adding the identification information of the target object to the user's favorites list. Therefore, the user can subsequently view favorite objects of the user in the favorites list.

S205, switching the second content to the first content or a third content when a further content switching operation based on a media content stream in the media content playing interface is received, wherein the first content and the third content are different media contents in the media content stream.

The first content and the third content may be different media contents in the media content stream, for example, they may be media contents located on both sides of the second content and adjacent to the second content in the media content stream of the media content playing interface. For example, the first content may be the media content played on the media content playing interface when the content switching operation in S202 is received; the third content may be, in addition to the first content, another media content adjacent to the second content in the media content stream on the media content playing interface. When the media content playing interface is a video playing interface, the first content and/or the third content are, for example, video contents. The second content and the first content and/or the third content may be different types of media content.

For example, when the user wants to continue watching other media content on the media content playing interface, the user can perform a content switching operation again, such as performing a vertical slide operation on the media content playing interface. Correspondingly, when receiving the user's content switching operation, the electronic device can switch the second content displayed in the media content playing interface to the first content or the third content, such as canceling the second content and the content associated with the target object, and the first content or the third content is played in the media content playing interface.

Taking the content switching operation as a vertical sliding operation as an example, when the content switching operation is a sliding operation of sliding downwards, the first content can be played in the media content playing interface, and when the content switching operation is a sliding operation of sliding upwards, the third content can be played in the media content playing interface; or, when the video playing operation is a sliding operation of sliding upward, the first content can be played in the media content playing interface, and when the video playing operation is a sliding operation of sliding downwards, the third content can be played on the media content playing interface.

The information display method provided by the embodiment can display the associated information of the target object on the upper layer of the interface background associated with the target object, display the detailed information of the target object, collect the target object, or continue to display the target object in the media content based on the corresponding triggering operation of the user, to meet different needs of the user and improve the user's experience.

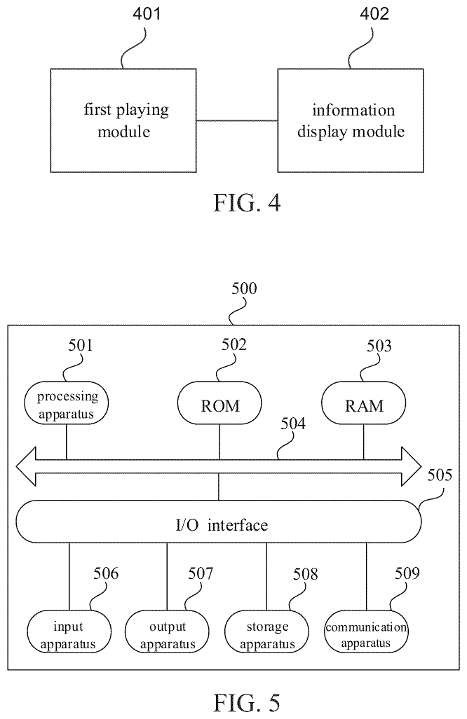

FIG. 4 is a structural block diagram of an information display apparatus provided by an embodiment of the present disclosure. The apparatus can be implemented by software and/or hardware, and can be configured in an electronic device. For example, the apparatus can be configured in a mobile phone or tablet computer, and can display the associated information of the target object in the media content playing interface by executing the information display method. As shown in FIG. 4, the information display device provided by the embodiment may include: a first playing module 401 and an information display module 402.

The first playing module 401 is configured to a first content on a media content playing interface;

The information display module 402 is configured to switch the first content to a second content in response to a content switching operation by a first user based on a media content stream in the media content playing interface, the second content is associated information of a target object, the associated information includes description information of the target object, and at least part of the associated information is displayed in the form of bullet comments information.

The information display device provided by the embodiment using a first playing module for playing a first content on a media content playing interface; using an information display module for switching the first content to a second content in response to a content switching operation by a first user based on a media content stream in the media content playing interface, the second content is the associated information of a target object, the associated information includes the description information of the target object, and at least part of the associated information is displayed in the form of bullet comments information. In this embodiment, the associated information of the target object is displayed to the user in the media content playing interface, and at least part of the associated information of the target object is displayed in the form of bullet comments information, which can enrich the content displayed on the media content playing interface and the presentation form of the content on the media content playing interface, and improve the user's information viewing efficiency and user experience.

In the above embodiment, the positional relationship between the target object and the first user may satisfy a preset condition.

In the above embodiment, the bullet comments information includes at least one selected from the group consisting of relationship information between the target object and the first user, operation information performed by a second user with respect to the target object and, relationship information between the target object and a target object set.

In the above embodiment, the relationship information between the target object and the first user includes: distance information between the target object and the first user, and/or operation information performed by the first user with respect to the target object; and/or the operation information performed by a second user with respect to the target object includes: evaluation information posted or interaction information performed by the second user with respect to the target object; and/or the relationship information between the target object and a target object set includes: ranking information of the target object in the target object set or evaluation level information of the target object in the target object set.

In an embodiment, the information display apparatus provided by this embodiment may further include: a detail displaying module, which is configured to display the target in response to a detail viewing operation with respect to the target object after switching the first content to the second content.

In the above embodiment, the bullet comments information may include the evaluation information posted by the second user with respect to the target object, and the detail displaying module can be configured to: switch a current interface from the media content playing interface to a detail interface of the target object, and display a preset first interface content in the detail interface; or switch the current interface from the media content playing interface to the detail interface of the target object, and display the content of a second interface in the detail interface, the content of the second interface includes the evaluation information triggered by the detail viewing operation.

In an embodiment, the information display apparatus provided by the embodiment may further include: a collection module, which is configured to add the target object to a user's favorites list in response to a favoriting operation with respect to the target object after the switching the first content to the second content.

In the above embodiment, the information display module 402 can be configured to: display a interface background associated with the target object on the media content playing interface, and display the second content on an upper layer of the interface background.

In the above embodiment, the information display module 402 can be configured to: display an object card of the target object and the bullet comments information on the upper layer of the interface background; the object card is configured to display description information of the target object.

In the above embodiment, a first background color of the object card is determined based on a second background color of the interface background displayed in the media content playing interface.

In an embodiment, the information display apparatus provided by the embodiment may further include: a background switching module, which is configured to, after the displaying an object card of the target object and the bullet comments information on the upper layer of the interface background, switch the interface background displayed in the media content playing interface according to a preset switching condition, and update the first background color of the object card based on the second background color of a switched interface background.

In the above embodiment, the interface background is a picture content, an animation content or a video content associated with the target object.

In an embodiment, the information display apparatus provided by the embodiment may further include: a second playing module, which is configured to, after the switching the first content to a second content, switch the second content to the first content or a third content in response to a further content switching operation by the first user based on a media content stream in the media content playing interface; the first content and the third content are different media contents in the media content stream.

In the above embodiment, the first content and/or the third content may be a video content.

Referring now to FIG. 5, a schematic structural diagram of an electronic device (e.g., terminal device) 500 suitable for implementing embodiments of the present disclosure is shown. The terminal devices in the embodiments of the present disclosure may include, but are not limited to, mobile phones, notebook computers, digital broadcast receivers, personal digital assistants (Personal Digital Assistants, PDAs), tablet computers (PAD), portable multimedia players (Portable Media Players), etc. PMP), vehicle-mounted terminals (such as vehicle-mounted navigation terminals), etc., as well as fixed terminals such as digital TV (Television, TV), desktop computers, etc. The electronic device shown in FIG. 5 is only an example and should not impose any limitations on the functions and scope of use of the embodiments of the present disclosure.

As shown in FIG. 5, the electronic device 500 may include a processing apparatus (e.g., a central processor, a graphics processor, etc.) 501, which can execute various appropriate actions and processes according to a program stored in a read-only memory (ROM) 502 or a program loaded into a random-access memory (RAM) 503 from a storage apparatus 508. In the RAM 503, various programs and data required for the operation of the electronic device 500 are also stored. The processing device 501, the ROM 502 and the RAM 503 are connected to each other by a bus 504. An input/output (I/O) interface 505 is also connected to the bus 504.

Generally, the following devices may be connected to the I/O interface 505: input apparatus 506 including, for example, touch screens, touch pads, keyboards, mice, cameras, microphones, accelerometers, gyroscopes, etc.; an output apparatus 507 including, for example, a liquid crystal display (LCD), a speaker, a vibrator, or the like; storage apparatus 508 including, for example, magnetic tape, hard disk, etc.; and a communication apparatus 509. The communication apparatus 509 may allow the electronic device 500 to engage in wireless or wired communication with other devices to exchange data. While FIG. 5 illustrates electronic device 500 with various means, it should be understood that it is not required that all of the illustrated means be implemented or provided. More or fewer devices may alternatively be implemented or provided.

In particular, according to an embodiment of the present disclosure, the processes described above with reference to the flow charts may be implemented as a computer software program. For example, an embodiment of the present disclosure includes a computer program product comprising a computer program carried on a non-transitory computer readable medium, the computer program containing program code for performing the method illustrated by the flow chart. In such an embodiment, the computer program may be downloaded and installed from the network via the communication apparatus 509, or installed from the storage apparatus 508, or installed from the ROM 502. When this computer program is executed by the processing means 501, the above-described functions defined in the methods of the embodiments of the present disclosure are performed.

It should be noted that the computer-readable medium described above in this disclosure may be a computer-readable signal medium or a computer-readable storage medium or any combination of both. The computer readable storage medium may be, for example, but not limited to, an electronic, magnetic, optical, electromagnetic, infrared, or semiconductor system, apparatus, or device, or any combination of the foregoing. More specific examples of a computer readable storage medium may include, but are not limited to, an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the present disclosure, a computer readable storage medium may be any tangible medium that contains, or stores a program for use by or in connection with an instruction execution system, apparatus, or device. In the present disclosure, a computer readable signal medium may include a propagated data signal with computer readable program code embodied therein, either in baseband or as part of a carrier wave. Such a propagated data signal may take many forms, including, but not limited to, an electromagnetic signal, an optical signal, or any suitable combination of the foregoing. A computer readable signal medium may also be any computer readable medium that is not a computer readable storage medium that can communicate, propagate, or transport a program for use by or in connection with an instruction execution system, apparatus, or device. Program code embodied on a computer readable medium may be transmitted using any appropriate medium, including but not limited to electrical wiring, optical fiber cable, RF (radio frequency), etc., or any suitable combination of the foregoing.

In some implementation, the clients, servers may communicate using any currently known or future developed network protocol, such as HTTP, and may be interconnected with any form or medium of digital data communication (e.g., a communication network). Examples of communication networks include a local area network (“Local Area Network, LAN”), a wide area network (“Wide Area Network, WAN”), an internetwork (e.g., the Internet), and end-to-end networks (e.g., ad hoc end-to-end networks), as well as any currently known or future developed network.

The above-mentioned computer-readable medium may be included in the above-mentioned electronic device; it may also be present separately and not incorporated into the electronic device.

The above-described computer-readable medium carries one or more programs which, when executed by the electronic device, cause the electronic device to: play a first content on a media content playing interface; switch the first content to a second content in response to a content switching operation by a first user based on a media content stream in the media content playing interface, the second content is associated information of a target object, the associated information includes description information of the target object, and at least part of the associated information is displayed in the form of bullet comments information.

The storage medium may be a non-transitory storage medium.

Computer program code for carrying out operations of the present disclosure may be written in one or more programming languages or combinations thereof, including without limitation an object-oriented programming language such as Java, Smalltalk, C++ and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the scenario involving a remote computer, the remote computer may be connected to the user's computer through any type of network, including a local area network (LAN) or a wide area network (WAN), or the connection may be made to an external computer (for example, through the Internet using an Internet Service Provider).

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or operations or combinations of special purpose hardware and computer instructions.

The units described in the embodiments of the present disclosure may be implemented by means of software or by means of hardware. Therein, the name of the unit/module does not in some cases constitute a limitation of the unit per se.

The functionality described above herein can be performed, at least in part, by one or more hardware logic components. For example, and without limitation, illustrative types of hardware logic components that can be used include Field-programmable Gate Arrays (FPGA), Application-specific Integrated Circuits (ASIC), Application-specific Standard Products (ASSP), System-on-a-chip systems (SOC), Complex Programmable Logic Devices (CPLD), etc.

In the context of the present disclosure, a machine-readable medium may be a tangible medium that can contain, or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of the machine-readable storage medium would include an electrical connection based on one or more wires, a portable computer diskette, a hard disk, a random-access memory (RAM), a read-only memory (ROM), an erasable programmable read-only memory (EPROM or Flash memory), an optical fiber, a convenient compact disc read-only memory (CD-ROM), an optical storage device, a magnetic storage device, or any suitable combination of the foregoing.

According to one or more embodiments of the present disclosure, example 1 provides an information display method, including:
playing a first content on a media content playing interface;
switching the first content to a second content in response to a content switching operation by a first user based on a media content stream in the media content playing interface, wherein the second content is associated information of a target object, the associated information includes description information of the target object, and at least part of the associated information is displayed in the form of bullet comments information.

According to one or more embodiments of the present disclosure, in example 2 of the method according to example 1, a positional relationship between the target object and the first user satisfies a preset condition.

According to one or more embodiments of the present disclosure, in example 3 of the method according to example 1, the bullet comments information includes at least one selected from the group consisting of relationship information between the target object and the first user, operation information performed by a second user with respect to the target object and, relationship information between the target object and a target object set.

According to one or more embodiments of the present disclosure, in example 4 of the method according to example 3, the relationship information between the target object and the first user includes: distance information between the target object and the first user, and/or operation information performed by the first user with respect to the target object; and/or
the operation information performed by a second user with respect to the target object includes: evaluation information posted or interaction information performed by the second user with respect to the target object; and/or
the relationship information between the target object and a target object set includes: ranking information of the target object in the target object set or evaluation level information of the target object in the target object set.

According to one or more embodiments of the present disclosure, example 5 of the method according to any one of examples 1 to 4, after the switching the first content to a second content, further includes:
displaying detailed information of the target object in response to a detail viewing operation with respect to the target object.

According to one or more embodiments of the present disclosure, in example 6 of the method according to example 5, the bullet comments information comprises the evaluation information posted by a second user with respect to the target object, and the displaying detailed information of the target object includes:
switching a current interface from the media content playing interface to a detail interface of the target object, and displaying a preset first interface content in the detail interface; or
switching the current interface from the media content playing interface to the detail interface of the target object, and displaying a content of a second interface in the detail interface, wherein the content of the second interface includes the evaluation information triggered by the detail viewing operation.

According to one or more embodiments of the present disclosure, example 7 of the method according to any one of examples 1 to 4, after the switching the first content to a second content, further includes:
adding the target object to a user's favorites list in response to a favoriting operation with respect to the target object.

According to one or more embodiments of the present disclosure, in example 8 of the method according to any one of examples 1 to 4, the switching the first content to a second content includes:
displaying a interface background associated with the target object on the media content playing interface, and displaying the second content on an upper layer of the interface background.

According to one or more embodiments of the present disclosure, in example 9 of the method according to example 8, the displaying the second content on an upper layer of the interface background includes:
displaying an object card of the target object and the bullet comments information on the upper layer of the interface background, wherein the object card is configured to display description information of the target object.

According to one or more embodiments of the present disclosure, in example 10 of the method according to example 9, a first background color of the object card is determined based on a second background color of the interface background displayed in the media content playing interface.

According to one or more embodiments of the present disclosure, example 11 of the method according to example 10, after the displaying an object card of the target object and the bullet comments information on the upper layer of the interface background, further includes:
switching the interface background displayed in the media content playing interface according to a preset switching condition, and updating the first background color of the object card based on the second background color of a switched interface background.

According to one or more embodiments of the present disclosure, in example 12 of the method according to example 8, the interface background is a picture content, an animation content or a video content associated with the target object.

According to one or more embodiments of the present disclosure, example 13 of the method according to any one of examples 1 to 4, after the switching the first content to a second content, further includes:
switching the second content to the first content or a third content in response to a further content switching operation by the first user based on a media content stream in the media content playing interface, wherein the first content and the third content are different media contents in the media content stream.

According to one or more embodiments of the present disclosure, in example 14 of the method according to example 13, the first content and/or the third content is a video content.

According to one or more embodiments of the present disclosure, example 15 provides an information display device is provided, which includes:
a first playing module, configured to a first content on a media content playing interface;
an information display module, configured to switch the first content to a second content in response to a content switching operation by a first user based on a media content stream in the media content playing interface, wherein the second content is associated information of a target object, the associated information includes description information of the target object, and at least part of the associated information is displayed in the form of bullet comments information.

According to one or more embodiments of the present disclosure, example 16 provides an electronic device, which includes:
one or more processors; and
a memory, configured to store one or more programs, a computer program product is provided,
when the one or more programs are executed by the one or more processors, the one or more processors are caused to implement the information display method described in any one of examples 1 to 14.

According to one or more embodiments of the present disclosure, example 17 provides a computer-readable storage medium, on which computer programs are stored, when the computer programs are executed by the processor, the information display method described in any one of examples 1 to 14 is implemented.

According to one or more embodiments of the present disclosure, example 18 provides a computer program product, when the computer program product is executed by a computer, the computer is caused to implement the information display method described in any one of examples 1 to 14.

Those skilled in the art should understand that the disclosure scope involved in the present disclosure is not limited to embodiments composed of specific combinations of the above technical features, but should also cover embodiments composed of the above technical features or without departing from the above disclosed concept. Other embodiments may be formed by any combination of equivalent features. For example, embodiments are formed by replacing the above features with technical features disclosed in this disclosure (but not limited to) with similar functions.

Furthermore, although operations are depicted in a specific order, this should not be understood as requiring that these operations be performed in the specific order shown or performed in a sequential order. Under certain circumstances, multitasking and parallel processing may be advantageous. Likewise, although several specific implementation details are included in the above discussion, these should not be construed as limiting the scope of the present disclosure. Certain features that are described in the context of separate embodiments can also be implemented in combination in a single embodiment. Conversely, various features that are described in the context of a single embodiment can also be implemented in multiple embodiments separately or in any suitable sub combination.

Although the subject matter has been described in language specific to structural features and/or methodological acts, it is to be understood that the subject matter defined in the appended claims is not necessarily limited to the specific features or acts described above. Rather, the specific features and acts described above are merely example forms of implementing the claims.

What is claimed is:

1. An information display method, comprising:
playing a first content on a media content playing interface; and
switching the first content to a second content in response to a content switching operation by a first user based on a media content stream in the media content playing interface, wherein the second content is associated information of a target object, the associated information comprises description information of the target object, and at least part of the associated information is displayed in a form of dynamic comment information.

2. The method according to claim 1, wherein a positional relationship between the target object and the first user satisfies a preset condition.

3. The method according to claim 1, wherein the dynamic comment information comprises at least one selected from the group consisting of relationship information between the target object and the first user, operation information performed by a second user with respect to the target object, and relationship information between the target object and a target object set.

4. The method according to claim 3, wherein the relationship information between the target object and the first user comprises: at least one selected from the group consisting of distance information between the target object and the first user, or operation information performed by the first user with respect to the target object; and/or
the operation information performed by the second user with respect to the target object comprises: evaluation information posted or interaction information performed by the second user with respect to the target object; and/or
the relationship information between the target object and the target object set comprises:
at least one of ranking information of the target object in the target object set or evaluation level information of the target object in the target object set.

5. The method according to claim 1, after the switching the first content to a second content, further comprising:
displaying detailed information of the target object in response to a detail viewing operation with respect to the target object.

6. The method according to claim 5, wherein the dynamic comment information comprises evaluation information posted by a second user with respect to the target object, and the displaying detailed information of the target object comprises:
switching a current interface from the media content playing interface to a detail interface of the target object, and displaying a preset first interface content in the detail interface; or
switching the current interface from the media content playing interface to the detail interface of the target object, and displaying a content of a second interface in the detail interface, wherein the content of the second interface comprises evaluation information triggered by the detail viewing operation.

7. The method according to claim 1, after the switching the first content to a second content, further comprising:
adding the target object to a user's favorites list in response to a favoriting operation with respect to the target object.

8. The method according to claim 1, wherein the switching the first content to a second content comprises:
displaying an interface background associated with the target object on the media content playing interface, and displaying the second content on an upper layer of the interface background.

9. The method according to claim 8, wherein the displaying the second content on an upper layer of the interface background comprises:
displaying an object card of the target object and the dynamic comment information on the upper layer of the interface background, wherein the object card is configured to display description information of the target object.

10. The method according to claim 9, wherein a first background color of the object card is determined based on a second background color of the interface background displayed in the media content playing interface.

11. The method according to claim 10, after the displaying an object card of the target object and the dynamic comment information on the upper layer of the interface background, further comprising:
switching the interface background displayed in the media content playing interface according to a preset switching condition, and updating the first background color of the object card based on a second background color of a switched interface background.

12. The method according to claim 8, wherein the interface background is a picture content, an animation content or a video content associated with the target object.

13. The method according to claim 1, after the switching the first content to a second content, further comprising:
switching the second content to the first content or a third content in response to a further content switching operation by the first user based on the media content stream in the media content playing interface, wherein the first content and the third content are different media contents in the media content stream.

14. The method according to claim 13, wherein at least one selected from the group consisting of the first content or the third content is a video content.

15. (canceled)

16. An electronic device, comprising:
at least one processor; and
a memory in communication with the at least one processor, wherein the memory stores a computer program executable by the at least one processor, upon the computer program being executed by the at least one processor, the at least one processor executes an information display method, which comprises:
playing a first content on a media content playing interface; and
switching the first content to a second content in response to a content switching operation by a first user based on a media content stream in the media content playing interface, wherein the second content is associated information of a target object, the associated information comprises description information of the target object, and at least part of the associated information is displayed in a form of dynamic comment information.

17. A non-transitory computer-readable storage medium, wherein the computer-readable storage medium stores computer instructions, the computer instructions are used to enable a processor to implement an information display method, which comprises:
playing a first content on a media content playing interface; and
switching the first content to a second content in response to a content switching operation by a first user based on a media content stream in the media content playing interface, wherein the second content is associated information of a target object, the associated information comprises description information of the target object, and at least part of the associated information is displayed in a form of dynamic comment information.

18. (canceled)

19. The electronic device according to claim 16, wherein a positional relationship between the target object and the first user satisfies a preset condition.

20. The electronic device according to claim 16, wherein the information display method, after the switching the first content to a second content, further comprising:
displaying detailed information of the target object in response to a detail viewing operation with respect to the target object.
